(19) United States
(12) Patent Application Publication
(10) Pub. No.: US 2023/0059290 A1
(43) Pub. Date: Feb. 23, 2023

(54) POWER ELECTRONICS PARAMETER INDEPENDENCY USING MEMRISTOR CONTROL

(71) Applicant: THE FLORIDA STATE UNIVERSITY RESEARCH FOUNDATION, INC., Tallahassee, FL (US)

(72) Inventors: Sihun Song, Tallahassee, FL (US); Yanjun Shi, Tallahassee, FL (US)

(73) Assignee: THE FLORIDA STATE UNIVERSITY RESEARCH FOUNDATION, INC., Tallahassee, FL (US)

(21) Appl. No.: 17/816,098

(22) Filed: Jul. 29, 2022

Related U.S. Application Data
(60) Provisional application No. 63/236,165, filed on Aug. 23, 2021.

(51) Int. Cl. G05B 19/042; H02M 1/00

(52) U.S. Cl. CPC G05B 19/042; H02M 1/0012; G05B 2219/2639

(57) ABSTRACT

The systems and methods described herein involve a power converter control system that uses a physical or virtual memristor in place of a standard resistor at a filtering stage of the power converter. The memristive low pass filter adjusts a cutoff frequency based on the output voltage in a way such that adaptive response to transient features is achieved. The use of the physical or virtual memristor provides the benefit of producing a self-adaptive passband rather than requiring manual intervention from a user. The result is an improvement in the output power quality of the power converter, which may allow for usage of the power converter, even given significant component degradation.

### CROSS-REFERENCE TO RELATED PATENT APPLICATION

The present application is related to and claims priority from Application No. 63/236,165, filed Aug. 23, 2021 titled “POWER ELECTRONICS PARAMETER INDEPENDENCY USING MEMRISTOR CONTROL.”

### BACKGROUND

Using control systems for power converter devices is deeply embedded into the hardware development cycle to achieve high efficiency, power density, and dynamic performance for the power converters. In engineering practice, the design of power converter controls is influenced by power filter parameter uncertainties. Filter parametric variations are typically caused by the saturation and aging of inductors, uncertainty of load input filters, and uncertainty and/or variation of grid impedance. In addition, while the industry is embracing model-based specification methodology in power system design, the requirement for controllers to adapt to a larger range of applications has raised significantly over application-specific control designs.

Power converters often employ low-pass filter stages that may be used to reduce the impact of voltage ripples. One prior approach to handling parameter uncertainties includes robust control methods, which use sophisticated mathematical models with predictive algorithms or observers to provide sufficient performance by including uncertainties in the model. Some control methods offer stable operation under a parameter change of 10% from nominal. Some control methods provide solutions that allow for 15% to 50% variations in LCL filter parameters while remaining stable. With some methods, stability is achieved under 50% grid side filter and 20% direct current (DC) side filter variations. A limited number of research explore impedance-shaping methods that offer robustness to parameter uncertainties. One method provides a virtual impedance-based control with 10% filter parameter variation, but the effects of greater variation are neglected. Some of these designs may depend on using the hardware as a specification, leading to a time-consuming development procedure. Furthermore, the tolerances for parametric variation in recent robust controls are quite narrow.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIGS. 1A-1B illustrate example schematics of memristor control circuits, in accordance with one or more embodiments of the disclosure.

FIGS. 2A-2C illustrates example control logic flow diagrams, in accordance with one or more embodiments of the disclosure.

FIG. 3 illustrates example testing results, in accordance with one or more embodiments of the disclosure.

FIG. 4 illustrates example testing results, in accordance with one or more embodiments of the disclosure.

FIG. 5 illustrates example testing results, in accordance with one or more embodiments of the disclosure.

FIGS. 6A-6C illustrate example testing results, in accordance with one or more embodiments of the disclosure.

FIG. 7 illustrates an example method, in accordance with one or more embodiments of this disclosure.

FIG. 8 illustrates an example of a computing system, in accordance with one or more embodiments of this disclosure.

### DETAILED DESCRIPTION

This disclosure relates to, among other things, power electronics parameter independency using memristor control. Particularly, in some cases, the disclosure may relate to a power converter control system that uses a physical or virtual memristor in place of a standard resistor at a filtering stage of the power converter. A memristor (also known as a memory resistor) may be a type of passive circuit element that may maintain a relationship between the time integrals of current and voltage across a two-terminal element. In this manner, the resistance of a memristor may vary according to a memristance function, allowing access to a “history” of applied voltage or current. That is, a memristor may be an electrical component that may regulate the flow of electrical current in a circuit and may remember the amount of charge that has previously flowed through it. The memristor is a passive element that may not alter existing resonant frequencies. Both the standard resistor and the memristor may be used as a part of a passband filter of the power converter. However, using the standard resistor may require a user to manually change the resistor to adjust the resistance if it is desired to adjust the passband. In contrast, the use of the physical or virtual memristor provides the benefit of producing a self-adaptive passband rather than requiring manual intervention from a user.

That is, in an attempt to provide stable operation and performance for power electronic converters, a new control method is described herein. A conventional power converter control loop may have a feedforward branch with a low pass filter compensator. In contrast, the method described herein uses a virtual memristive low pass filter which adjusts the cutoff frequency based on the output voltage in a way such that adaptive response to transient features is achieved. Implementation may be performed by linearizing the equations governing the behavior of a memristor and directly programming the control algorithm onto a digital signal processor. Thus, a greater stable operation area is covered by the proposed controller, as opposed to conventional active damping control. As aforementioned, the memristor may either be implemented as a physical memristor that is connected to the power converter through a physical control circuit, or may be a virtual memristor implemented in control logic associated with the power converter. For example, a power converter may be in electrical communication with one or more microcontrollers that may include control logic used to simulate operation of a virtual memristor. Additionally, while reference may be made to a “memristive low pass filter” herein, any type of memristive impedance may also be used.

More particularly, the feedforward branch including the memristive low pass filter may be used to achieve stable performance under extreme parameter variation. The memristive low pass filter may provide an adaptive passband, which the virtual memristor control (VMC) method may use to suppress unwanted dynamics caused by filter components. Performance of the method may be analyzed and verified by processor-in-the-loop (PiL) and control-hardware-in-the-loop (CHIL) simulations on a converter model (for example, a three-level dc-dc buck converter model or any other type of model). Output filter parameters may be varied (for example, from 1.0 pu to 0.1 pu or any other range of values), and the method may be validated through a comparison to a conventional virtual impedance based on active damping control.

A transfer function associated with the memristive low pass filter may be provided below in Equation 1.

$${H}_{f} ( ω ) = \frac{1}{1 + j ω {R}_{a} {C}_{f}^{′}} \qquad ( Equation 1 )$$

where Rα is the memristance of the filter memristor defined in Equation 2 provided below, and C_{f} is the low pass filter capacitance.

R_{α}=αR_{A}+(1−α)R_{B} (Equation 2)

With respect to Equation 2, R_{A} and R_{B} may be the minimum and maximum memristance values, respectively. However, to achieve the desired transient and steady-state responses, R_{A} may become the maximum and R_{B} may become the minimum. The value α may represent a weight value and may determine the state of the memristor. The behavior of this weight value may be defined in Equation 3 as a function of the current i(t) through the memristor.

$$\frac{d α}{dt} = \frac{i ( t )}{{Q}_{0}} \prod ( α ) \qquad ( Equation 3 )$$

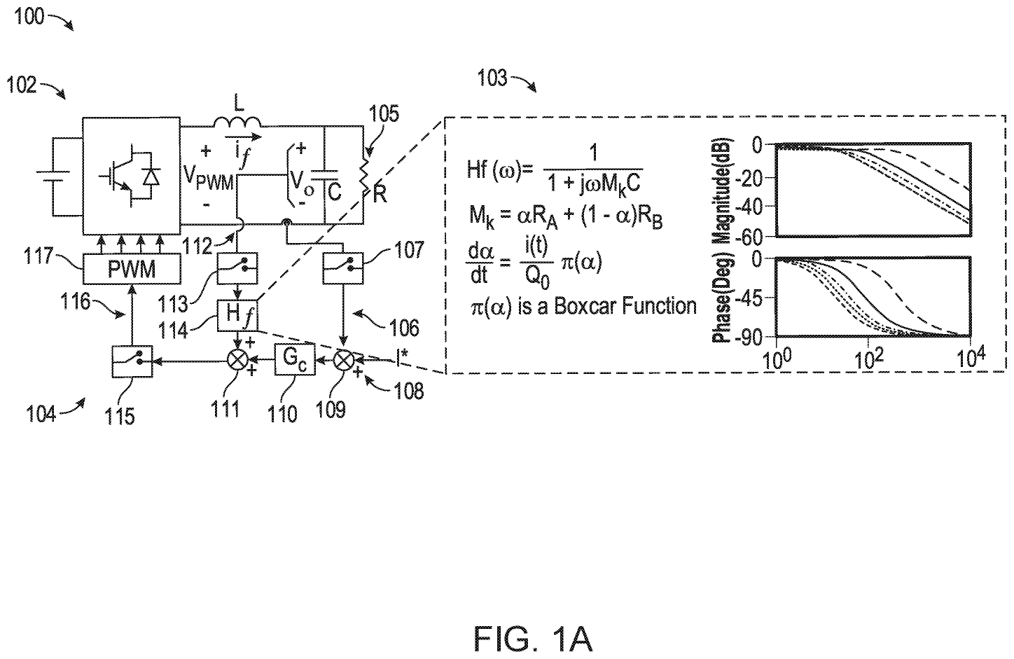

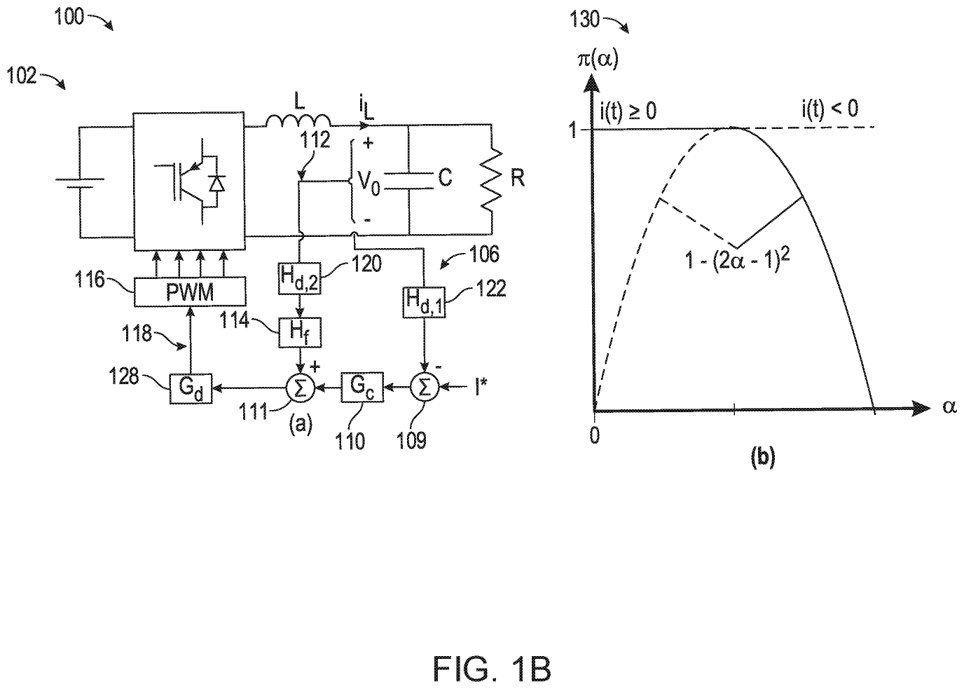

Π(α) may represent a normalized window function (as shown in FIG. 1B) that may be used to constrain the weight within a range of values (for example, between 0 and 1 or any other range of values), and Q₀ is the total charge needed to completely dope the memristor.

An adaptive passband for the power converter may be achieved by creating a relationship between the cutoff frequency and the current through the memristor. To capture the ramp-up during the transient while attenuating high-frequency noise, the values for C_{f} and R_{B} may be chosen such that the cutoff frequency of the undoped memristive low pass filter is equal to a quarter (or any other percentage) of the switching frequency of the power converter. The value for R_{A} may then be chosen such that the cutoff frequency of the doped memristive low pass filter is significantly smaller than the switching frequency. The theoretical desired cutoff frequency for a DC system at steady state is the pure DC magnitude, implying an infinite maximum memristance. However, using a large R_{A} value may decrease the response near steady state, and convergence to the operating point may be prolonged. This may be resolved by defining a finite R_{A} and decreasing Q₀, which shortens the settling time and increases overshoot in voltage.

The tuning of the memristor parameters takes into account the unidirectional flow of the DC signal. Since dα/dt is dependent on the current through the memristor, the weight may only increase and approach a value of 1, at which point the system should be in a steady-state. Hence, the parameters may be tuned such that the memristance reaches R_{A}. A poorly tuned memristive low pass filter can cause a large overshoot. This is especially apparent when the memristor becomes fully doped before the transients have settled. Conversely, when the memristor does not become fully doped before the steady-state, the change in passband introduces artificial perturbation to the compensated signal. Then, R_{A} is large enough to reduce sensitivity to sensor noise while small enough to allow the memristor to become fully doped.

The method offers high tolerance to time delay, sensor noise, and filter effects, while the control design is less dependent on the topology of the plant in which the power converter is located. Robustness is assessed by identifying the boundary of allowable parametric variation. To accomplish this, the stability of the system for each point in the parameter space is determined, which defines the stable operation area.

While the systems and methods described herein may be described in association with the use case of a power converter, the same control systems may also be applicable in any other context as well, and this use case is not intended to be limiting in any way.

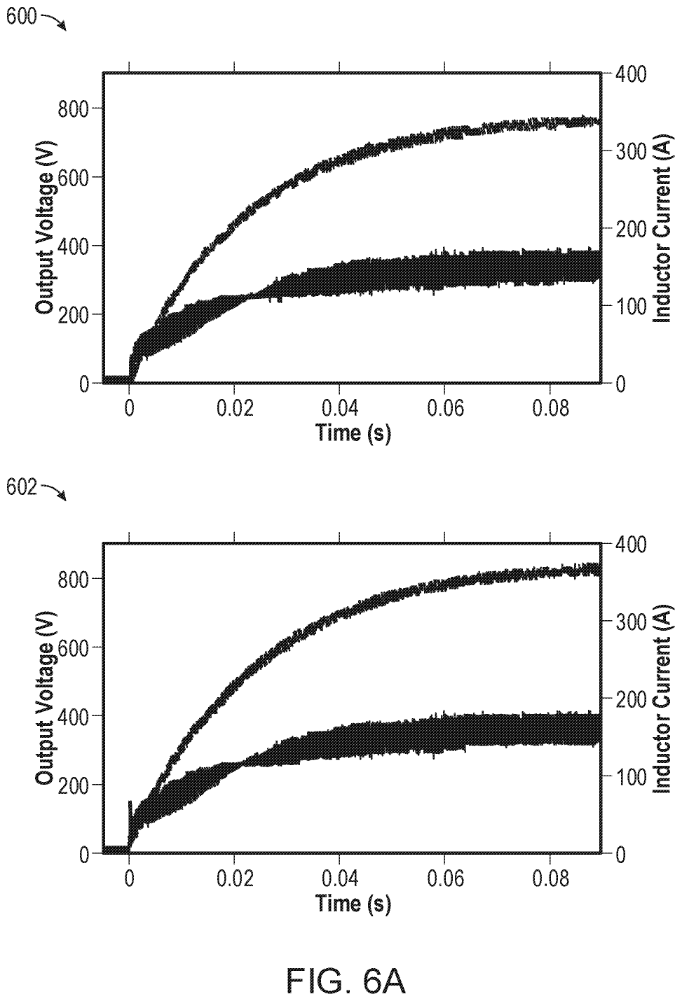

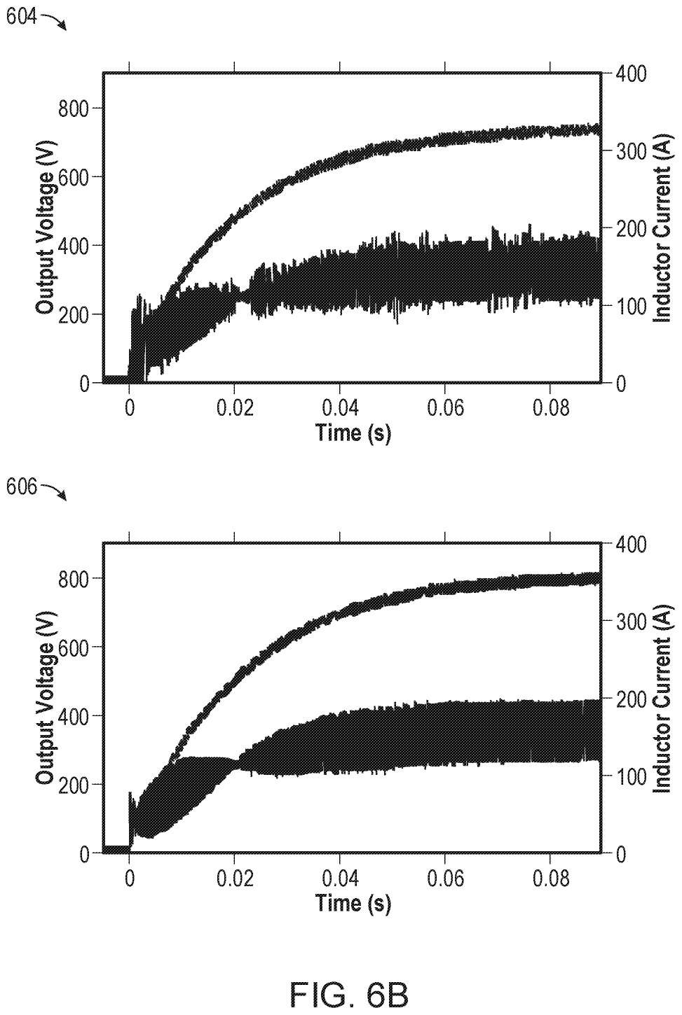

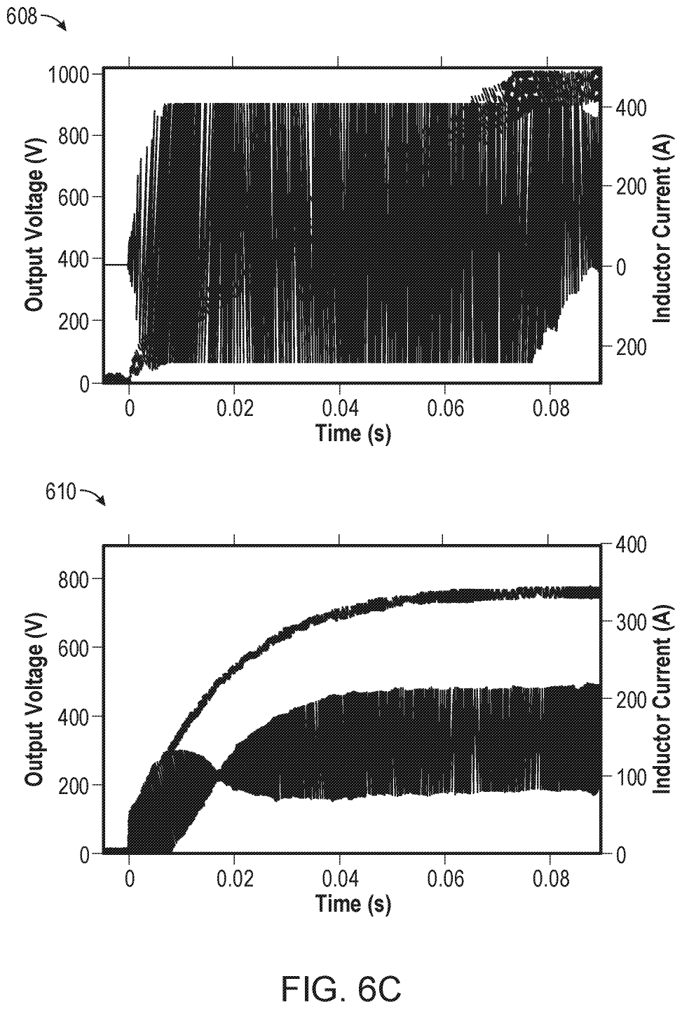

Turning to the figures, FIG. 1 illustrates an example system 100, in accordance with one or more embodiments of the disclosure. The system 100 may include a power converter 102 with an LC filter (however, any other type of filter may also be applicable), a load 105 (for example, represented by a resistance value, R), and a control circuit 104 that may be used to improve stability of the power converter 102 under an extended range of parametric variation. Particularly, the control circuit 104 may be used to improve the output power quality of the power converter 102 when filter parameters are decreased significantly below benchmark values (example data illustrating how the control circuit 104 may be used to maintain performance even when degradation of the power converter 102 occurs is shown in FIG. 6). In some cases, the control circuit 104 may be used to modify the impedance characteristic of the power converter 102 to change the apparent impedance of the power converter 102 when observed from the load 105.

More particularly, the control circuit 104 may include a first input branch 106, a second input branch 108, and/or a third input branch 112, as well as an output branch 116. In some cases, the various input branches may represent signal paths for signals produced by various sensors that may be capturing data from the power converter 102 for processing. While the figure may depict three distinct signal branches, any of the signals that are received by the control circuit 104 from any of the branches may also be received from any other number of “branches” as well (as one non-limiting example, any of the signals may be received at one pin of a microcontroller). That is, the branches may simply illustrate distinct signals that may be received and may not necessarily limit the control circuit 104 to including separate sources of electrical communication for each of the signals.

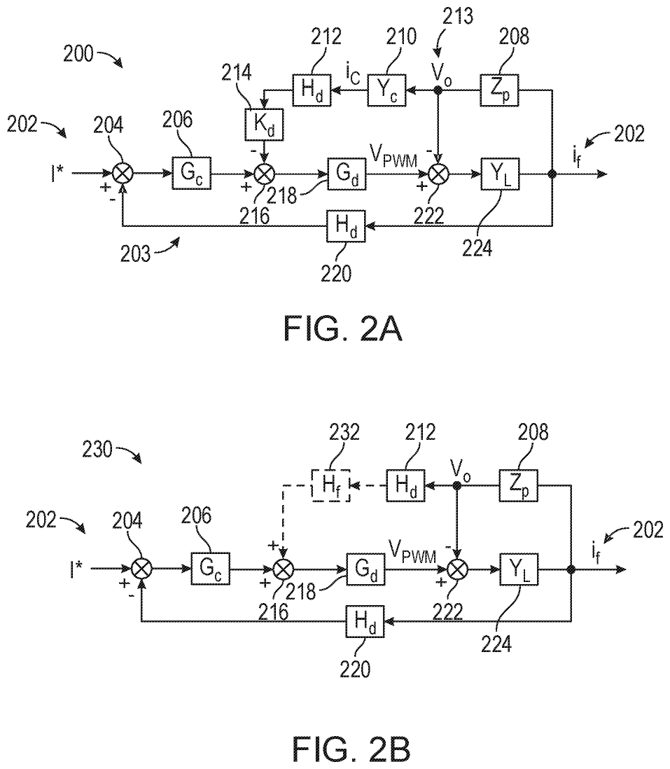

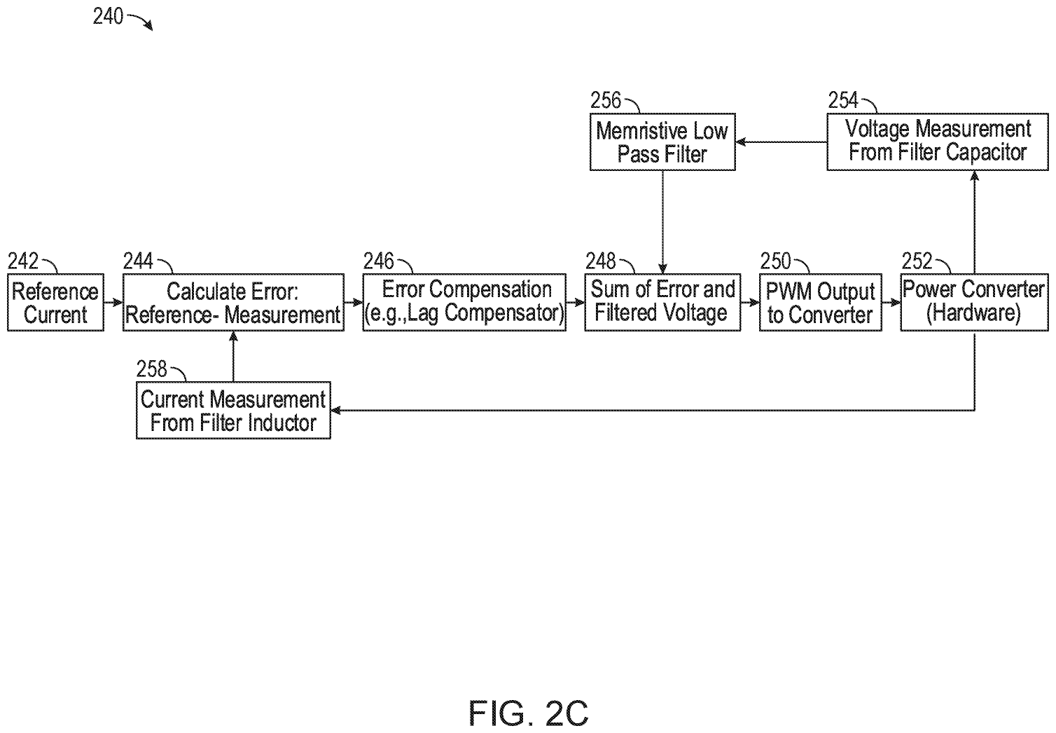

Block 110, as well as any other blocks illustrated in FIGS. 1A-1B, FIGS. 2A-2C, or otherwise, may be hardware-based components included in any of the circuits and/or may be software module(s) implemented using one or more local and/or remote computing devices (for example, machine 800). As an example implementation of software module(s), any of the blocks may represent processes that may be performed by a microcontroller (or similar type of device) that receives any of the inputs shown as being provided to any of the blocks and/or also produces any of the outputs shown as being produced by any of the blocks as well. In some cases, the microcontroller may be capable of running a circuit simulation model (or may be in communication with another computing device that may run a circuit simulation model). That is, the control “circuit” may represent a circuit including hardware components, may be a microcontroller (or any other type of local or remote computing device, such as a laptop computer, desktop computer, server, etc.) that may perform some or all of the processing associated with the various blocks, and/or a combination of the two. Furthermore, in some cases, the terms “control circuit” and “control system” may be used interchangeably herein.

Turning to the operation of the control circuit 104, the first input branch 106 may receive a measurement from the power converter 102. This measurement may be any type of measurement, such as a voltage value, a current value, and/or any other type of value. These measurements may be performed by any number of different types of sensors (for example, current sensors and voltage sensors, such as a Rogowski coil and a resistive bridge circuit, respectively, and/or any other types of sensors). Branch 112 may be the output voltage, measured across the filter capacitor ‘C’ shown in circuit 102. Branch 106 may be the inductor current, measured by the current going through the filter inductor 1′ shown in circuit 102. The memristor branch (the third branch 112) may receive the output voltage (i.e., capacitor voltage), and the first branch 106 may receive the inductor current. This is merely exemplary, however. Other devices may receive different values in each branch or may even have different number of branches in the control circuit.

In one or more embodiments, the measurement may be transmitted through the first branch 106 to block 109. In one or more embodiments, the first branch 106 may also include an optional switch 107, however, such a switch is not necessarily required. Block 109 may receive the measured signal from the power converter 102 and may compare it to a reference signal that is received from the second branch 108. The reference signal (and/or the measurement received from the power converter 102 through the first branch 106) may also include any type of value, such as current, voltage, etc. The reference signal may be the operating point during steady-state operation (i.e., nominal value for the variable of interest). The reference signal may be the same type of value as the measurement received from the first branch such that a direct comparison may be made between the measured signal and the reference signal. For example, both values may be current values, voltage values, etc. As shown in FIG. 1B, the block 109 may represent a summation of the signal received by block 109 from the first branch and the reference signal received from the second branch 108. However, either the sign of the signal received from the first branch and/or the reference signal may be switched, such that the operation that is performed at block 109 is essentially a difference determination (that is, a difference between the measured signal and the reference signal). The measured signal may have its inherited polarity changed to its complementary polarity (i.e., positive to negative, negative to positive, neutral to neutral). In certain devices, the difference may be measured by taking subtracting the reference signal from the measured signal instead of subtracting the measured signal from the reference signal. Alternatively, a difference may simply be determined without needing to perform the sign change.

Based on the comparison performed at block 109, an error value may be determined. The error value may indicate the degree of difference between the measurement from the power converter 102 and the reference signal received through the second branch 108. For example, the error value may represent a difference in magnitude between the two values. However, the error value may provide an indication of any other type of difference between the two values as well. This error value may be received by block 110, which may perform error compensation based on the error value received from block 109. As one non-limiting example, the compensation operation may be performed as follows: (i) error is multiplied by some gain, (ii) error is integrated over time, (iii) values from (i) and (ii) are added. Not all compensations are necessarily performed in this manner, however.

After the error compensation is performed by block 110, the resulting value may then be provided to block 111. In addition to receiving the output of the compensation performed by block 110, block 111 may also receive a second signal from the third branch 112. The third branch 112 may be a branch of the control circuit 104 that includes the memristive filter (or more generally, a memristive impedance), which is represented by block 114. The third branch 112 may also include a switch 113, but, similar to the first branch 106, the switch 112 may not necessarily be required. While reference may be made herein to a memristive low pass filter or memristive filter, any type of memristive impedance may also be applicable as well. That is, the use of the term “memristive low pass filter” is not intended to be limiting in any way.

The behavior of the memristive filter (for example, block 114) may be defined by the mathematic equations shown box 103 (as well as Equations 1-3 provided above). A Bode plot diagram of the filter is also shown as plot 130 with respect to FIG. 1B. As shown in box 103, the H_{f}(ω) function may be the transfer function equation that defines an ideal first order low pass filter, with respect to the complex component jω in Laplace transform. C may be the low pass filter capacitance, and the resistance variable, Mₖ, may be defined as shown below the transfer function. R_{A} and R_{B} may be the lower and upper resistance values, respectively, and α may be the weight variable determining the memristor's resistance value at time t. The derivative dw/dt may define the behavior of α, where a window function Π(α) is used to keep the value between 0 and 1. The function i(t) may be the current that passes through the terminals of the memristor, and Q₀ may be a constant to adjust the sensitivity of the memristor to the current value.

After receiving the second signal from the third branch 112, and the compensated output from block 110, block 111 may perform a summation of the two values. This summed output may then be output back to the power converter 102 as control signals. For example, the output may be provided to the power converter as one or more PWM signals, which may be represented by block 116. Also optional switch 115. These PWM signals may be used to change the quality of power 102 associated with the power converter. The PWM signals may operate the switching actions of power electronic devices (for example, solid state switches) within the power converter 102 to allow power flow to the load 105 from the source in a controlled way. The filter components L and C allow for the switching motion to be “smoothed” by passively filtering. FIGS. 2A and 2B, show a model of PWM output 218 to inductor current 202. The output voltage may be modeled by 208.

FIG. 1B illustrates additional details regarding the system 100. For example, block 112 may represent sensor characteristics for any sensors that obtain data associated with the first branch 106 and block 120 may represent sensor characteristics for any sensors that obtain data associated with the second branch 112. It should be noted, however, that while reference may be made to one or more different sensors capturing data associated with the power converter 102, such data may not necessarily be captured by standalone sensors. That is, the measurements may be obtained directly from the power converter 102 by a microcontroller (or similar type of computing device). Additionally, block 128 may represent the gain to convert the compensated control value to a duty cycle for the PWM output back to the power converter 102.

FIGS. 2A-2B illustrate example control logic flow diagrams (for example flow diagram 200 and flow diagram 230), in accordance with one or more embodiments of the disclosure. The flow diagram 200 may illustrate a logical flow for a power converter control system including a resistor instead of a memristive low pass filter, and the flow diagram 230 may illustrate a logical flow for a power converter control system including a memristive low pass filter (or any other type of memristive impedance). That is, the flow diagram 230 of FIG. 2B may provide another representation of the system 100 illustrated in FIGS. 1A-1B. In this manner, block 208, block 210, and block 224 may represent characteristics of the power converter 102 shown in FIGS. 1A-1B. For example, block 208 may represent the impedance of any load that is connected to the power converter, block 210 may represent an impedance of the capacitor shown in the power converter 102, and block 224 may represent the impedance of the inductor shown in the power converter 102. It should be noted that while typically “Y” may represent an admittance value, this is simply the inverse of impedance. Additionally, similar to FIGS. 1A-1B, while certain inputs and/or outputs included in FIGS. 2A-2B are shown as “I” (for example, indicating current values) or “V” (for example, indicating voltage values), these types of values are not intended to be limiting. For example, the reference signal may be a voltage value (or any other type of value) instead of a current value. Additionally, i_{f} may represent the filter inductor current, i_{c} may represent the filter capacitor current, and Vo may represent the output voltage 213 (i.e., capacitor voltage).

Beginning with FIG. 2A, the flow diagram 200 starts with block 204. Block 204 (which may be similar to block 109 in FIG. 1A) may involve performing an operation based on two input signals. The first input signal 202 may be a reference signal, which may be the same as, or similar to, the reference signal received from the second branch 108 in FIG. 1A. That is, the reference signal may be a reference current, a reference voltage, and/or any other type of value. The second input signal 203 may be the same as, or similar to, block 122 shown in FIG. 1B, and may represent a measurement by a sensor represented by block 220 of the power converter. Block 204 may determine a difference between the two input signals, where the difference may represent an amount of error produced by the power converter. This difference may be provided as an output to block 206 (which may be the same as, or similar to, block 110 in FIG. 1A).

Block 206 may compensate for the error value determined in block 204. This compensation value output may then be provided to block 216, which may be the same as, or similar to, block 111 of FIGS. 1A-1B. Similar to block 111 of FIGS. 1A-1B, block 216 may also receive an input from blocks 212 and 214. Block 212 may represent a sensor characteristic of a sensor performing measurements associated with the power converter, and block 214 may represent a proportional gain value. The output of block 216 may then be provided to block 218, which may generate output signals to provide back to the power converter. For example, the signals produced by block 218 may be PWM signals that are provided to block 222. Block 222 may represent an artifact for converting physical models to virtual subsystems. The first input signal 202 (for example, an inductor current and/or any other type of input value) may be calculated by multiplying a difference between an output voltage 213 and target voltage (for example, produced by block 218) and inductor admittance 224. The diagram may illustrate that the voltage drops across the components in a loop equals the voltage supplied.

Turning to FIG. 2B, the flow diagram 230 may include many of the same blocks as the flow diagram 200 of FIG. 2A. However, flow diagram 230 also include block 232, which may represent a memristive low pass filter (or more generally speaking, a memristive impedance).

The flow diagram 200 may be sensitive to time delay and filter effects, and the resistance (Rd) may need to be manually tuned through experimentation. In contrast, the flow diagram 230 may introduce a feedforward branch with a memristive low pass filter (and/or any other type of memristive impedance in general) and may include an adaptive passband. As aforementioned, the flow diagram 230 (and flow diagram 240 described below) that include the memristor instead of the resistor may provide the benefit that the passband associated with the power converter controller may be self-adaptive, whereas a power converter controller including a standard resistor may require manual tuning by a user.

FIG. 2C illustrates another example control logic flow diagram 240, in accordance with one or more embodiments of the disclosure. The flow diagram 240 may be the same as flow diagram 230, but may provide further description of the elements included in the flow diagram 230. The flow diagram 240 may begin with operation 203, which may involve determining a reference current. In some cases, the reference current may be a nominal value for the plant (for example, for the power converter). Operation 203 may be followed by operation 204, which may include calculating an amount of error between a reference current and a measured current. This error calculation may involve determining a current mismatch between a current sensor reading of the power converter and a reference current. As illustrated in the figure, the measured current may be determined as part of the feedback loop formed by the logic flow diagram 202. That is, operation 218 may involve obtaining the current measurement. In some cases, the current measurement may be a current value read from a current sensor attached to the power converter output filter inductor. This may be specifically located at a filter inductor of the power converter, in some cases.

In some embodiments, operation 204 may be followed by operation 206, which may involve performing error compensation. This may include a function that may use the amount of error determined in operation 204 to compensate for any mismatch in measured and reference current in order to achieve a desired operating point (for example, the reference current). Operation 206 may be followed by operation 208, which may involve a summation of the amount of error and a filtered voltage value. This may produce a combined value of compensated error and the filtered voltage value. The addition of the filtered voltage value may provide instantaneous response to high magnitude dynamics. In some cases, the filtered voltage value may be obtained through at least operations 214 and 216 described below. Operation 208 may be followed by operation 210, which may involve producing a pulse width modulated (PWM) output to the power converter. This may be a low pass filter with memristive behavior (as described above) applied to the voltage measurements. This may be an adaptive passband based on the properties of the memristor. In operation 210, the summed value produced by operation 208 may be converted into control signals (for example, gating signals) through the use of PWM. This may be output to the power converter (for example, as shown in operation 212) and may dictate states for power electronics in the power converter.

In some embodiments, operations 210/212 may be followed by operations 214 and 216. Operation 214 may involve obtaining a voltage measurement from the filter capacitor of the power converter. Operation 218, as aforementioned, may involve obtaining a current measurement from the filter inductor of the power converter. In this manner, the flow diagram 202 may be in the form of a feedback loop in which current and voltage measurements are performed continuously or periodically, and the control of the power converter is adjusted accordingly. Additionally, following operation 214 may be operation 216, which may involve providing the voltage measurements to the memristor of the memristive low pass filter (which may be a physical memristor or may be a virtual memristor). Operation 216 may then again be followed by operation 208 (as described above, the filtered voltage may be summed with the amount of error in operation 208.

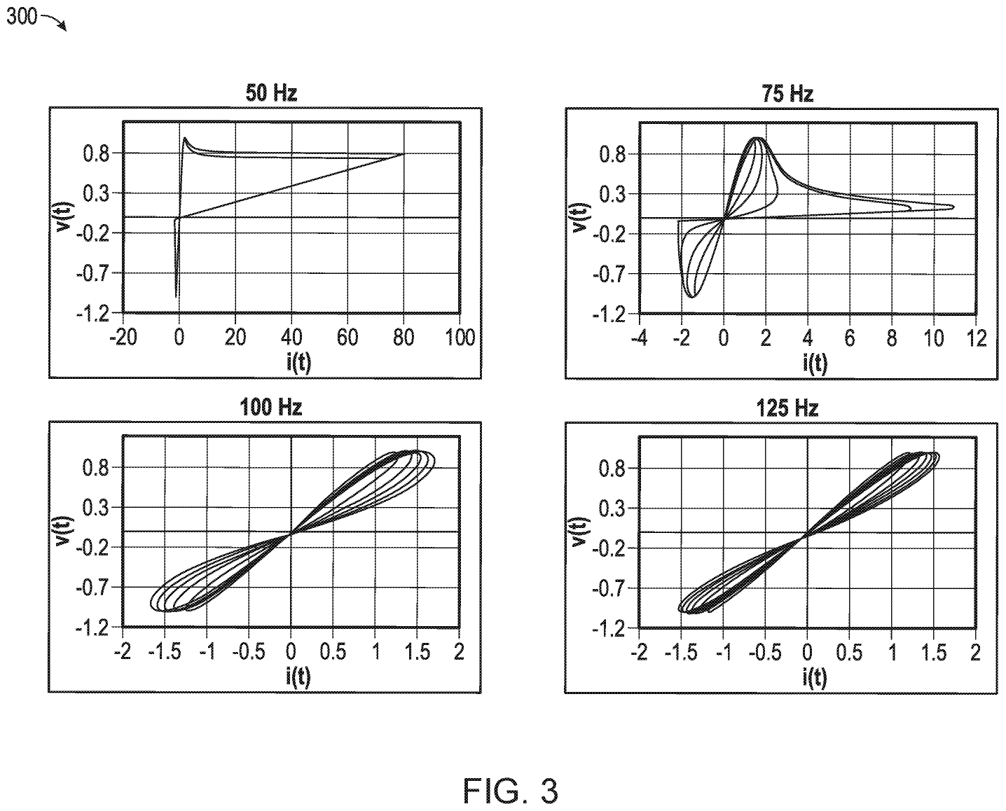

FIG. 3 illustrates example testing results 300, in accordance with one or more embodiments of the disclosure. The testing results may be presented in the form of one or more plots. The plots may include current versus voltage for a given sine wave (for example, 1V) at different frequencies across a memristor.

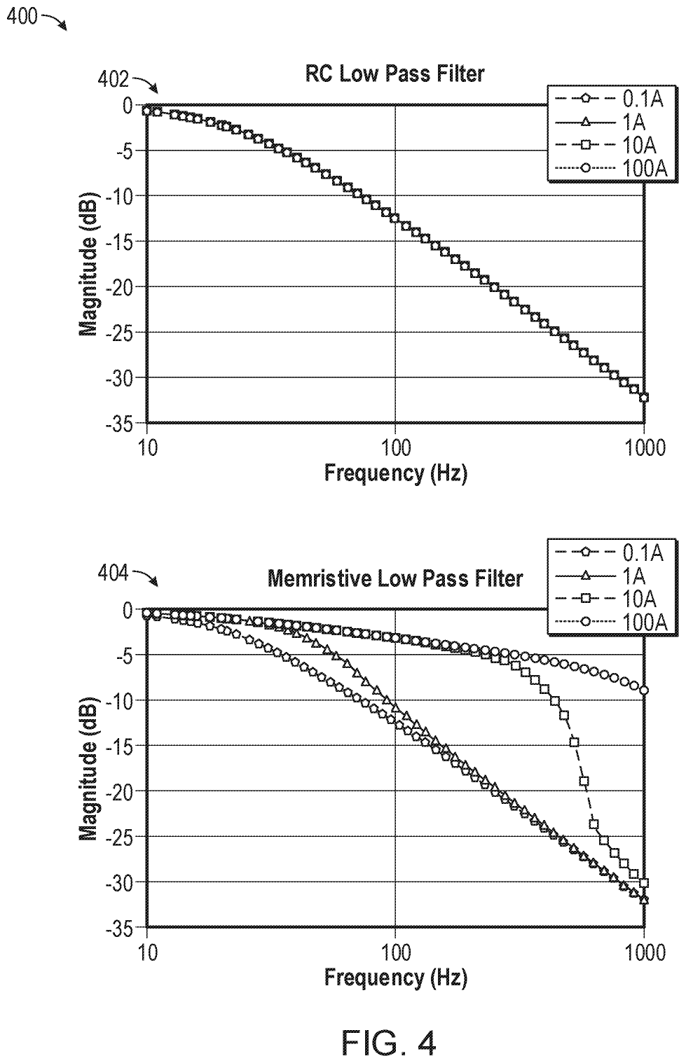

FIG. 4 illustrates example testing results, in accordance with one or more embodiments of the disclosure. The testing results may illustrate a difference between an RC (for example, a low pass filter using a standard resistor) low pass filter used in a power converter (shown in plot 402) and a memristive low pass filter used in the power converter (shown in plot 404). Plots 402 and 404 may be plots showing frequency on the x-axis and magnitude on the y-axis. As shown in the plot 402, the RC low pass filter may exhibit similar magnitude to frequency ratios for different input currents. In contrast, plot 404 shows that the relationship changes depending on the input current amplitude when the memristor is used in place of the standard resistor.

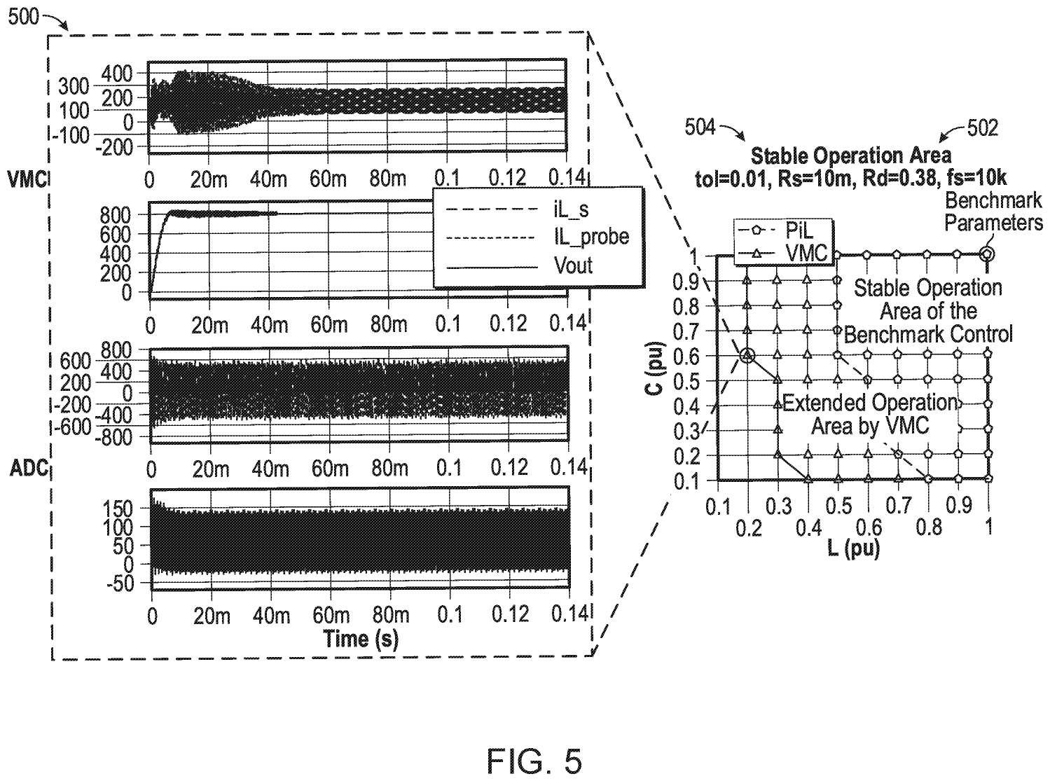

FIG. 5 illustrates example testing results, in accordance with one or more embodiments of the disclosure. FIG. 5 illustrates an extended stable operation area that results when a memristor is used in place of a standard resistor. The stable operation area may be obtained via changing the power converter filter parameters at a consistent interval and determining stability at the operating state. For example, the figure depicts a first stable operation area 502 that results when a standard resistor is used, as well as a second stable operation area 504 that is added to the first stable operation area 502 when the memristive low pass filter is used in place of the resistor.

The proposed control is tested via interfacing a controller to a real-time simulation environment. To obtain outputs in an ideal environment, PiL simulation is done with PSIM and a TI F28379D microcontroller board. The three-level buck converter model is loaded with benchmark parameters as shown in Table I. Input voltages at the voltage sources are set to half of Vdc. The microcontroller is executed with the VMC and a conventional active damping control (ADC) for comparison. To test the robustness to parameter uncertainty, 100 cases are run for each control method with LC filter parameters varying from 1.0 pu to 0.1 pu at 0.1 pu interval. Stability of each case is assessed by observing the steady state inductor current. By plotting the boundary of the stable cases on a grid with L and C as the axes, the stable operation area (SOA) is formed. The resulting chart of the SOA is shown in FIG. 4.

FIGS. 6A-6C illustrate example testing results, in accordance with one or more embodiments of the disclosure. Particularly, FIGS. 6A-6C show data indicating that the power quality produced by a power converter using a control circuit as descried herein (for example, control circuit 102 shown in FIGS. 1A-1B) is improved over the power quality produced by the same power converter without the control circuit, even when the components of the power converter are degraded.

Plots 600, 604, and 608 show output voltage and inductor current data produced by a power converter that does not involve the use of the control circuit, and plots 602, 606, and 610 show output voltage and inducer current data produced by the same power converter under the same conditions that does involve the use of the control circuit. Plots 600 and 602 in FIG. 6A show data produced for the power converter under one set of operating conditions, plots 604 and 606 in FIG. 6B show data produced under a second set of operating conditions (degradation of the power converter), and plots 608 and 610 in FIG. 6C show data produced under a third set of operating conditions (even further degradation of the power converter).

The plot 610 in particular shows that the control circuit described herein may allow for usage of the power converter even in cases of significant degradation of the power converter components, which may have otherwise made the power converter inoperable as shown in plot 608. Even with such noise, the control circuit is able to dampen the output much more effectively than a traditional ADC. Furthermore, the results imply that the control circuit is capable of attenuating potentially destabilizing oscillations while leaving the ripple untouched. The output voltage in the boundary cases such as in plot 610 remain strictly stable. These experimental results show that the control circuit is validated to provide greater damping of oscillation than the conventional virtual impedance based control method under extreme parametric variation. In addition to system stabilization, the output tracking in the system with the control circuit is much more effective.

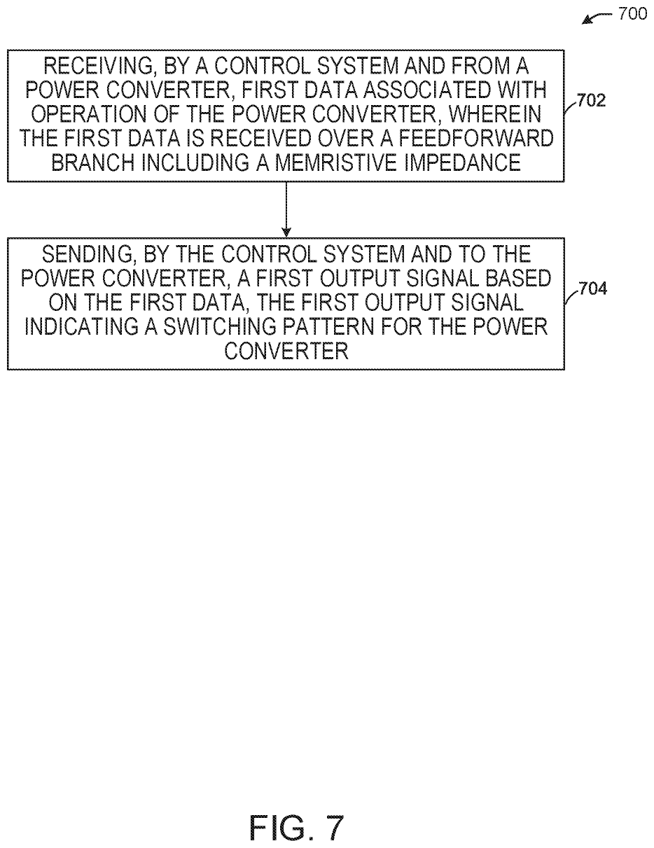

FIG. 7 illustrates an example method 700, in accordance with one or more embodiments of this disclosure. Block 702 of the method may include receiving, by a control system (for example, control circuit 104 or any other control circuit, system, device, etc.) and from a power converter, first data associated with operation of the power converter (for example, power converter 102 or any other power converter), wherein the first data is received over a feedforward branch including a memristive impedance. Block 704 of the method 700 may include sending, by the control system and to the power converter, a first output signal based on the first data, the first output signal indicating a switching pattern for the power converter.

In one or more embodiments, the memristive impedance is a physical memristor or a virtual memristor that is implemented in control logic, and wherein the memristive impedance is a memristive low pass filter.

In one or more embodiments, the method 700 further includes receiving, by the control system, a reference value. The method 700 further includes receiving, by the control system and from the power converter, second data. The method 700 further includes calculating, by the control system, a first difference between the reference value and the second data from the power converter.

In one or more embodiments, the first difference represents an error value associated with the power converter and the method 700 further includes determining, by the control system, an error compensated output value based on an error compensation performed using the error value. The method 700 further includes determining, by the control system, a summation of the error compensated output value and the first data to produce a second output value, wherein the first output signal from the control system to the power converter is based on the second output value.

In one or more embodiments, a transfer function associated with the memristive impedance comprises a sum of a first value and a second value, wherein the first value includes a product of a first memristance value and a weight value, and wherein the second value includes a product of a second memristance value and the weight value.

In one or more embodiments, the first output signal is a pulse-width modulated (PWM) signal.

In one or more embodiments, the first data comprises at least one of: a voltage signal associated with a capacitor of the power converter and a current signal associated with an inductor of the power converter.

One or more operations of the methods, process flows, or use cases of FIGS. 1-7 may have been described above as being performed by a user device, or more specifically, by one or more program module(s), applications, or the like executing on a device. It should be appreciated, however, that any of the operations of the methods, process flows, or use cases of FIGS. 1-7 may be performed, at least in part, in a distributed manner by one or more other devices, or more specifically, by one or more program module(s), applications, or the like executing on such devices. In addition, it should be appreciated that the processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-7 may be described in the context of the illustrative devices, it should be appreciated that such operations may be implemented in connection with numerous other device configurations.

The operations described and depicted in the illustrative methods, process flows, and use cases of FIGS. 1-7 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-7 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

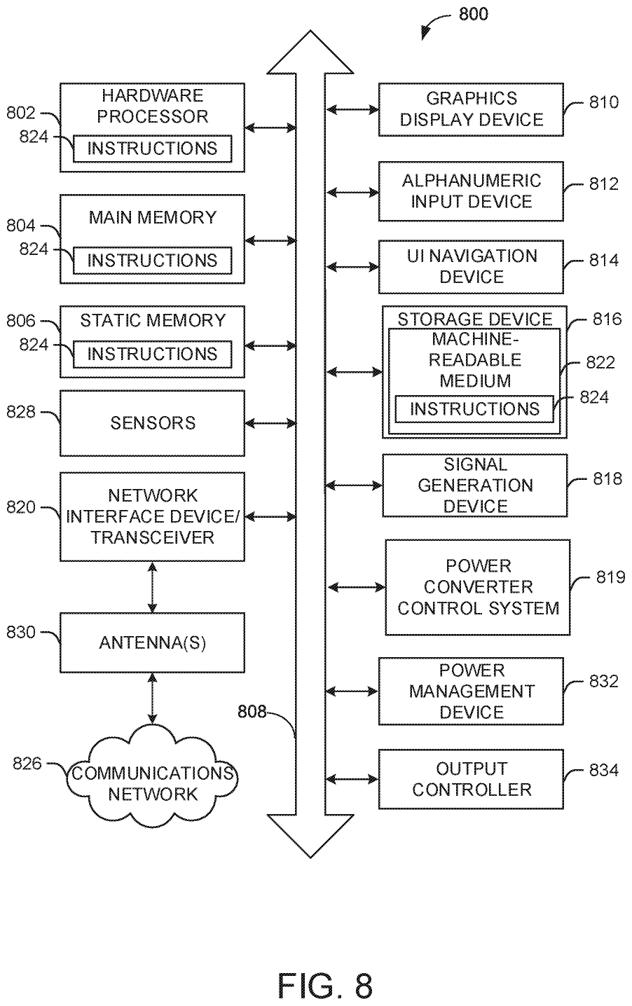

FIG. 8 depicts a block diagram of an example machine 800 upon which any of one or more techniques (e.g., methods) may be performed, in accordance with one or more example embodiments of the present disclosure (for example, the control circuit 104). In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a speaker), a power converter control system 819, a network interface device/transceiver 820 coupled to antenna(s) 830, and one or more sensors 828, such as a global positioning system (GPS) sensor, a compass, an accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

The power converter control system 819 may carry out or perform any of the operations and processes (e.g., operations described with respect to FIG. 2C or otherwise) described and shown above, and may facilitate the analysis and display of workplace disruption metrics, the display of workplace disruption scores and related data, the projected changes to workplace disruption scores, protocols governing workplaces, and the like.

It is understood that the above are only a subset of what the power converter control 819 may be configured to perform and that other functions included throughout this disclosure may also be performed by the power converter control 819.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that, individually and in combination, certain systems and methods. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A method comprising:
receiving, by a control system and from a power converter, first data associated with operation of the power converter, wherein the first data is received over a feedforward branch including a memristive impedance; and
sending, by the control system and to the power converter, a first output signal based on the first data, the first output signal indicating a switching pattern for the power converter.

2. The method of claim 1, wherein the memristive impedance is a physical memristor or a virtual memristor that is implemented in control logic, and wherein the memristive impedance is a memristive low pass filter.

3. The method of claim 1, further comprising:
receiving, by the control system, a reference value;
receiving, by the control system and from the power converter, second data; and
calculating, by the control system, a first difference between the reference value and the second data from the power converter.

4. The method of claim 3, wherein the first difference represents an error value associated with the power converter, and wherein the method further comprises:
determining, by the control system, an error compensated output value based on an error compensation performed using the error value; and
determining, by the control system, a summation of the error compensated output value and the first data to produce a second output value, wherein the first output signal from the control system to the power converter is based on the second output value.

5. The method of claim 1, wherein a transfer function associated with the memristive impedance comprises a sum of a first value and a second value, wherein the first value includes a product of a first memristance value and a weight value, and wherein the second value includes a product of a second memristance value and the weight value.

6. The method of claim 1, wherein the first output signal is a pulse-width modulated (PWM) signal.

7. The method of claim 1, wherein the first data comprises at least one of: a voltage signal associated with a capacitor of the power converter and a current signal associated with an inductor of the power converter.

8. A control system comprising:
one or more processors operable to execute a set of computer-executable instructions; and
memory operable to store the set of computer-executable instructions operable to:
receive, from a power converter, first data associated with operation of the power converter, wherein the first data is received over a feedforward branch including a memristive impedance; and
send, to the power converter, a first output signal based on the first data, the first output signal indicating a switching pattern for the power converter.

9. The control system of claim 8, wherein the memristive impedance is a physical memristor or a virtual memristor that is implemented in control logic, and wherein the memristive impedance is a memristive low pass filter.

10. The control system of claim 8, wherein the computer-executable instructions further cause the one or more processors to:
receive, by the control system, a reference value;
receive, by the control system and from the power converter, second data; and
calculate, by the control system, a first difference between the reference value and the second data from the power converter.

11. The control system of claim 10, wherein the first difference represents an error value associated with the power converter, and wherein the computer-executable instructions further cause the one or more processors to:
determine, by the control system, an error compensated output value based on an error compensation performed using the error value; and
determine, by the control system, a summation of the error compensated output value and the first data to produce a second output value, wherein the first output signal from the control system to the power converter is based on the second output value.

12. The control system of claim 8, wherein a transfer function associated with the memristive impedance comprises a sum of a first value and a second value, wherein the first value includes a product of a first memristance value and a weight value, and wherein the second value includes a product of a second memristance value and the weight value.

13. The control system of claim 8, wherein the first output signal is a pulse-width modulated (PWM) signal.

14. The control system of claim 8, wherein the first data comprises at least one of: a voltage signal associated with a capacitor of the power converter and a current signal associated with an inductor of the power converter.

15. A non-transitory computer-readable medium storing computer-executable instructions, that when executed by one or more processor, cause the one or more processors to:
receive, from a power converter, first data associated with operation of the power converter, wherein the first data is received over a feedforward branch including a memristive impedance; and
send, to the power converter, a first output signal based on the first data, the first output signal indicating a switching pattern for the power converter.

16. The non-transitory computer-readable medium of claim 15, wherein the memristive impedance is a physical memristor or a virtual memristor that is implemented in control logic, and wherein the memristive impedance is a memristive low pass filter.

17. The non-transitory computer-readable medium of claim 15, wherein the computer-executable instructions further cause the one or more processors to:
receive a reference value;
receive, from the power converter, second data; and
calculate a first difference between the reference value and the second data from the power converter.

18. The non-transitory computer-readable medium of claim 17, wherein the first difference represents an error value associated with the power converter, and wherein the computer-executable instructions further cause the one or more processors to:
determine an error compensated output value based on an error compensation performed using the error value; and
determine a summation of the error compensated output value and the first data to produce a second output value, wherein the first output signal to the power converter is based on the second output value.

19. The non-transitory computer-readable medium of claim 15, wherein a transfer function associated with the memristive impedance comprises a sum of a first value and a second value, wherein the first value includes a product of a first memristance value and a weight value, and wherein the second value includes a product of a second memristance value and the weight value.

20. The non-transitory computer-readable medium of claim 15, wherein the first output signal is a pulse-width modulated (PWM) signal.
